(19) United States
(12) Patent Application Publication
(10) Pub. No.: US 2020/0267490 A1
(43) Pub. Date: Aug. 20, 2020

(54) SOUND WAVE FIELD GENERATION

(71) Applicant: Harman Becker Automotive Systems GmbH, Karlsbad (DE)

(72) Inventor: Markus CHRISTOPH, Straubing (DE)

(73) Assignee: Harman Becker Automotive Systems GmbH, Karlsbad (DE)

(21) Appl. No.: 16/067,916

(22) PCT Filed: Dec. 14, 2016
(86) PCT No.: PCT/EP2016/081012

§ 371 Date: Jul. 3, 2018

(30) Foreign Application Priority Data
Jan. 4, 2016 (EP) 16150040.0

(51) Int. Cl. H04S 7/00; H04S 3/02

(52) U.S. Cl. CPC H04S 7/302; H04S 2400/01; H04S 2420/11; H04S 3/02

(57) ABSTRACT

To generate a sound wave field around a listening position in a target room, sound signals to be reproduced at a multiplicity of positions that are distributed in the target room in an arbitrary fashion are generated. Furthermore, an Ambisonic input signal is processed according to a modal beamforming algorithm to provide the sound signals. The modal beamforming algorithm includes matrixing according to a multiple-input multiple-output filtering algorithm.

### TECHNICAL FIELD

The disclosure relates to a system and method for generating a sound wave field.

### BACKGROUND

Two-dimensional or three-dimensional audio may be realized using a sound field description with a technique called Higher-Order Ambisonics. Ambisonics is a full-sphere surround sound technique which may cover, in addition to the horizontal plane, sound sources above and below the listener. Unlike other multichannel surround formats, its transmission channels do not carry loudspeaker signals. Instead, they contain a loudspeaker-independent representation of a sound field, which is then decoded to the listener's loudspeaker setup. This extra step allows a music producer to think in terms of source directions rather than loudspeaker positions, and offers the listener a considerable degree of flexibility as to the layout and number of loudspeakers used for playback. Ambisonics can be understood as a three-dimensional extension of mid/side (M/S) stereo, adding additional difference channels for height and depth. In terms of First-Order Ambisonics, the resulting signal set is called B-format. The spatial resolution of First-Order Ambisonics is quite low. In practice, that translates to slightly blurry sources, but also to a comparably small usable listening area or sweet spot.

The resolution can be increased and the sweet spot enlarged by adding groups of more selective directional components to the B-format. In terms of Second-Order Ambisonics these no longer correspond to conventional microphone polar patterns, but look like, e.g., clover leaves. The resulting signal set is then called Second-, Third-, or collectively, Higher-Order Ambisonics (HOA). However, common applications of the HOA technique require, dependent on whether a two-dimensional (2D) or three-dimensional (3D) wave field is processed, specific spatial configurations, notwithstanding whether the wave field is measured or reproduced: Processing of 2D wave fields requires cylindrical configurations and processing of 3D wave fields requires spherical configurations, each with a regular distribution of the microphones or loudspeakers.

### SUMMARY

An audio system, which is configured to generate a sound wave field around a listening position in a target room, includes a multiplicity of loudspeakers distributed in the target room in an arbitrary fashion. The system further includes at least one modal beamformer module connected upstream of the multiplicity of loudspeakers and downstream of at least one input signal path that receives at least one Ambisonic input signal. The at least one modal beamformer module includes a matrixing module that includes a multiple-input multiple-output filter module.

An audio reproduction method, which is configured to generate a sound wave field around a listening position in a target room, includes generating sound signals to be reproduced at a multiplicity of positions that are distributed in the target room in an arbitrary fashion. The method further includes processing an Ambisonic input signal according to a modal beamforming algorithm to provide the sound signals. The modal beamforming algorithm includes matrixing according to a multiple-input multiple-output filter algorithm.

A computer program product is configured to cause a processor to execute an audio reproduction method to generate a sound wave field around a listening position in a target room. The method includes generating sound signals to be reproduced at a multiplicity of positions that are distributed in the target room in an arbitrary fashion. The method further includes processing an Ambisonic input signal according to a modal beamforming algorithm to provide the sound signals. The modal beamforming algorithm includes matrixing according to a multiple-input multiple-output filtering algorithm.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system and methods may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a flow chart illustrating a simple acoustic Multiple-Input Multiple-Output (MIMO) system with M recording channels (microphones) and K output channels (loudspeakers), including a multiple error least mean square (MELMS) system or method.

FIG. 2 is a flowchart illustrating a 1×2×2 MELMS system or method applicable in the MIMO system shown in FIG. 1.

FIG. 3 is a flow chart of a system and method for generating spherical harmonics in a target room at a distinct position using a modified MELMS algorithm.

FIG. 4 is a signal flow chart illustrating an exemplary modal beamformer employing a multiple-input multiple-output filter module for matrixing.

### DETAILED DESCRIPTION

The HOA technique may enhance the performance of common audio systems such as home audio systems. However, as mentioned above, the HOA technique requires, dependent on whether a two-dimensional (2D) or three-dimensional (3D) wave field is processed, specific spatial configurations of the microphones or loudspeakers, notwithstanding whether the wave field is measured (decoded) or reproduced (encoded). Accordingly, processing of 2D wave fields requires cylindrical configurations and processing of 3D wave fields requires spherical configurations, each with a regular distribution of the microphones or loudspeakers. This reduces the versatility of audio systems employing HOA significantly. Versatile audio systems described herein utilize a Multiple-Input-Multiple-Output (MIMO) filtering system/method (also referred to as MIMO system) in combination with a Higher-Order-Ambisonic (HOA) system/method to approximate a desired sound field with an arbitrary loudspeaker arrangement as for, e.g., home applications. Thus, the acoustical performance of already existing home stereo systems can be enhanced by using an advanced signal processing framework, based on a combination of MIMO and HOA techniques adapted to arbitrary wave fields in a versatile way.

Multiple-input multiple-output (MIMO technology in room acoustic employs multiple transmitters at one end and multiple receivers at another end. In simple audio systems, a single transducer (e.g., microphone, loudspeaker) is used at the source, and another single transducer (e.g., loudspeaker, microphone) is used at the destination. In some cases, this gives rise to problems with multipath effects. When an acoustic wave field is met with obstructions such as walls, windows, doors and furniture, the wave fronts are scattered, and therefore take many paths to reach the destination. The late arrival of scattered portions of sound causes problems such as echoes, reverberations, cancellations, and intermittent reception. The use of two or more transducers, along with the transmission of multiple signals (one for each transducer) at the source and the destination, eliminates the backlog caused by multipath wave propagation. It has been found that, when combined with HOA in a specific way, the MIMO algorithm provides for directivity in form of spherical harmonics, particularly their basic functions, and allows for overcoming the restrictions set by the HOA algorithm, such as the limited form of the basic transducer configuration and the necessity of regularly distributed transducers, without reducing the benefits of the HOA algorithm.

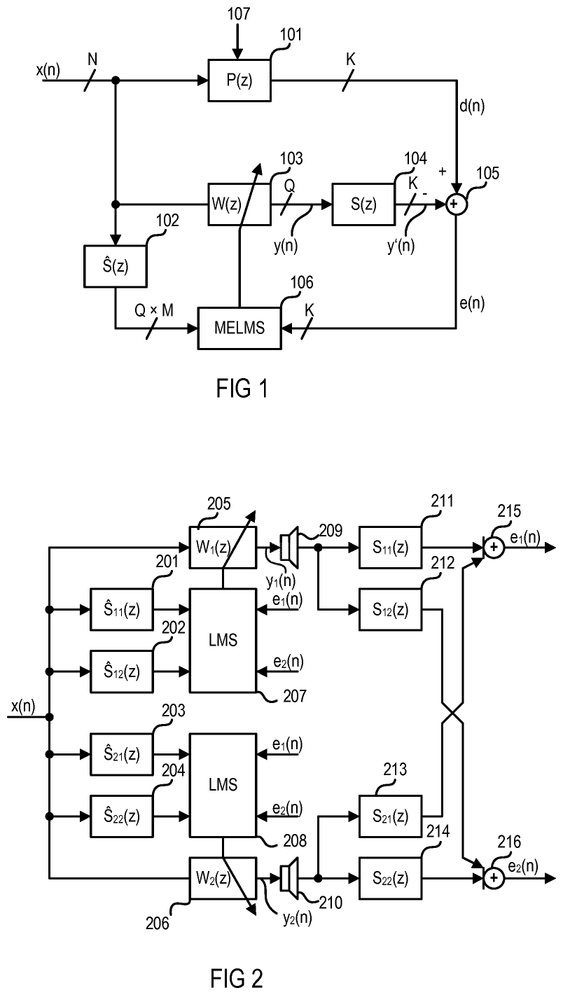

FIG. 1 is a signal flow chart of an equalizing multiple-input multiple-output (MIMO) system and method (generally referred to as a “system”), which may have a multiplicity of outputs (e.g., output channels for supplying output signals to Q≥1 groups of loudspeakers) and a multiplicity of (error) inputs (e.g., recording channels for receiving input signals from K≥1 groups of microphones). A group includes one or more loudspeakers or microphones that are connected to a single channel, i.e., one output channel or one recording channel. It is assumed that the corresponding room or loudspeaker-room-microphone system (a room in which at least one loudspeaker and at least one microphone is arranged) is linear and time-invariant and can be described by, e.g., its room acoustic impulse responses. Furthermore, N original input signals such as or including a mono input signal x(n) may be fed into (original signal) inputs of the MIMO system. The MIMO system may use a multiple error least mean square (MELMS) algorithm (e.g., the multiple filtered input least mean square algorithm) for filtering, e.g., equalization, but may employ any other adaptive control algorithm such as a (modified) least mean square (LMS), recursive least square (RLS), etc. Input signal x(n) is filtered by K primary paths 101, which are represented by primary path filter matrix P(z) on its way from, e.g., one loudspeaker to K microphones at different positions, and provides K desired signals d(n) at the end of primary paths 101, i.e., at the K microphones.

By way of the MELMS algorithm, which may be implemented in a MELMS processing module 106, a filter matrix W(z), which is implemented by an equalizing filter module 103, is controlled to change the original input signal x(n) such that the resulting Q output signals, which are supplied to Q loudspeakers and which are filtered by a filter module 104 with a secondary path filter matrix S(z), match the desired signals d(n). Accordingly, the MELMS algorithm evaluates the input signal x(n) filtered with a secondary pass filter matrix Ŝ(z), which is implemented in a filter module 102 and outputs Q×K filtered input signals, and K error signals e(n). The error signals e(n) are provided by a subtractor module 105, which subtracts K microphone signals y′(n) from the K desired signals d(n). The K recording channels with K microphone signals y′(n) are the Q output channels with Q loudspeaker signals y(n) filtered with the secondary path filter matrix S(z), which is implemented in filter module 104, representing the acoustical scene. Modules and paths are understood to be at least one of hardware, software and/or acoustical paths.

The MELMS algorithm is an iterative algorithm to obtain the optimum least mean square (LMS) solution. The adaptive approach of the MELMS algorithm allows for in situ design of filters and also provides a convenient method for readjusting the filters whenever a change occurs in the electro-acoustic transfer functions. The MELMS algorithm employs the steepest descent approach to search for the minimum of the performance index. This is achieved by successively updating filter coefficients by an amount proportional to the negative of gradient ∇(n), according to which w(n+1)=w(n)+μ(−∇(n)), where μ is the step size that controls the convergence speed and the final maladjustment. An approximation may be in such LMS algorithms so as to update the vector w using the instantaneous value of the gradient ∇(n) instead of its expected value, leading to the LMS algorithm.

FIG. 2 is a signal flow chart of an exemplary N×Q×K MELMS system and method (generally referred to as a “system”), wherein N is 1, Q is 2 and K is 2 and which is adjusted to create a bright zone at microphone 215 and a dark zone at microphone 216; i.e., it is adjusted for individual sound zone purposes. A “bright zone” represents an area where a sound wave field is generated in contrast to an almost silent “dark zone”. Input signal x(n) is supplied to four filter modules 201-204, which form a 2×2 secondary path filter matrix with transfer functions Ŝ11(z), Ŝ12(z), Ŝ21(z) and Ŝ22(z), and to two filter modules 205 and 206, which form a filter matrix with transfer functions W1(z) and W2(z). Filter modules 205 and 206 are controlled by least mean square (LMS) modules 207 and 208, whereby module 207 receives signals from modules 201 and 202 and error signals e₁(n) and e₂(n), and module 208 receives signals from modules 203 and 204 and error signals e₁(n) and e₂(n). Modules 205 and 206 provide signals y₁(n) and y₂(n) for loudspeakers 209 and 210. Signal y₁(n) is radiated by loudspeaker 209 via secondary paths 211 and 212 to microphones 215 and 216, respectively. Signal y₂(n) is radiated by loudspeaker 210 via secondary paths 213 and 214 to microphones 215 and 216, respectively. Microphone 215 generates error signals e₁(n) and e₂(n) from received signals y₁(n), y₂(n) and desired signal d₁(n). Modules 201-204 with transfer functions Ŝ₁₁(z), Ŝ₁₂(z), SŜ₂₁(z) and Ŝ₂₂(z) model the various secondary paths 211-214, which have transfer functions S₁₁(z), S₁₂(z), S₂₁(z) and S₂₂(z).

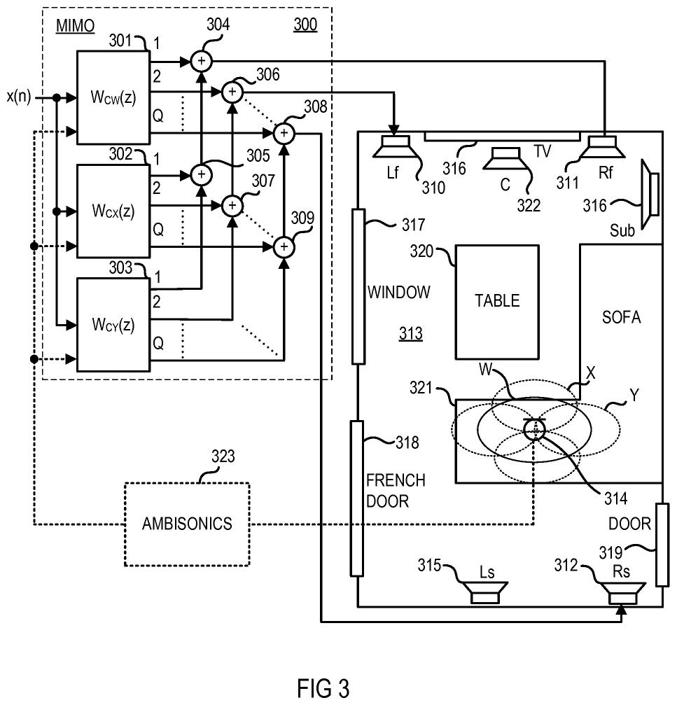

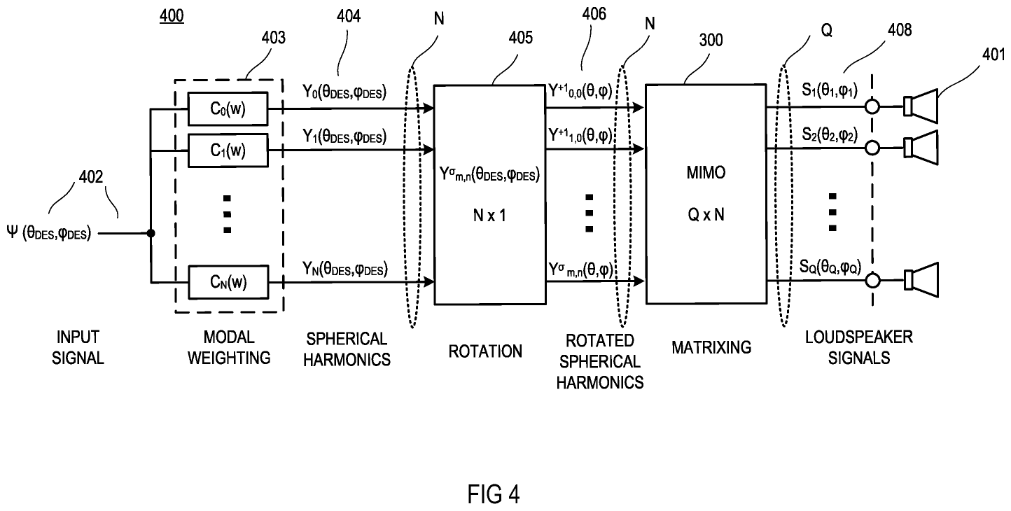

Referring to FIG. 3, the system/method described above in connection with FIGS. 1 and 2 may be used to generate arbitrary wave fields. To achieve this, the system/method shown in FIG. 1 has been modified so that primary path 101 is controllable. Primary path 101 may be controlled according to a desired listening room, e.g., a source room 107. The secondary path 104 may be implemented as a target room such as a home interior. In a simple setup, the acoustics of the desired listening room such as a concert hall, i.e., the source room 107, are established (modeled) at a particular listening position, i.e., at an actual listening position or sweet spot in the home interior. The actual listening position may be the position of a listener's ear, a point before and between a listener's two ears or the area around the head at its particular position in the target room. The signal to be reproduced may be an Ambisonic signal that is processed in a module (system, method or combination thereof) as shown in FIG. 4 which is, for example, a modal beamformer for Ambisonic panning.

Simple Ambisonic panning (or encoding) takes a source signal s and two parameters, the horizontal angle θ and the elevation angle φ. It positions the source at the desired angle by distributing the signal over the Ambisonic components with different gains for the corresponding Ambisonic signals W (Y_{0,0}⁺¹(θ, φ)), X (Y_{1,1}⁺¹(θ, φ)), Y (Y_{1,1}⁻¹(θ, φ)) and Z (Y_{1,0}⁺¹(θ, φ)):

$$w = s \cdot \frac{1}{\sqrt{2}} ,$$

x=s·cos θ·cos φ,

y=s·sin θ·cos φ, and

z=s·sin φ.

Being omnidirectional, the W channel always delivers the same signal, regardless of the listening angle. Thus it has more-or-less the same average energy as the other channels. W is attenuated by w, i.e., by about 3 dB (precisely, divided by the square root of two). The terms for X, Y, Z actually produce polar patterns of figure-of-eight. Taking their desired weighting values at angles θ and φ (x, y, z), and multiplying the result with the corresponding Ambisonic signals (X, Y, Z), the output sums lead to a figure-of-eight radiation pattern pointing now to the desired direction, given by the azimuth θ and elevation φ, utilized in the calculation of the weighting values x, y and z, having an energy content that copes with the W component, weighted by w.

The B-format components can be combined to derive virtual radiation patterns that cope with any first-order polar pattern (omnidirectional, cardioid, hypercardioid, figure-of-eight or anything in between) pointing in any three-dimensional direction. Several such beam patterns with different parameters can be derived at the same time to create coincident stereo pairs or surround arrays.

Simple Ambisonic decoding similarly uses a set of virtual microphones. For perfectly regular layouts, a simplified decoder can be generated by pointing a virtual cardioid microphone in the direction of each loudspeaker. Here is a square:

LF=(2W+X+Y)·\sqrt{8},

LB=(2W−X+Y)·\sqrt{8},

RB=(2W−X−Y)·\sqrt{8}, and

RF=(2W+X−Y)·\sqrt{8}.

The signs of the X and Y components are the essential part, the rest are gain factors. The Z component is discarded in the present exemplary case because it is not possible to reproduce height cues with just four loudspeakers in one plane. Beyond the theory outlined above, a real Ambisonic decoder may include a number of psycho-acoustic optimizations.

The spatial resolution of the exemplary first-order Ambisonics described above is quite low. In practice, that translates to slightly blurry sources, but also to a comparably small usable listening area or sweet spot. The resolution can be increased and the sweet spot enlarged by adding groups of more selective directional components to the B-format. The resulting signal set is then called Second-, Third-, or collectively, Higher-Order Ambisonics. For a given order [symbol] , full-sphere systems require ( [symbol] +1)² signal components, and 2 [symbol] +1 components are needed for horizontal-only reproduction.

FIG. 3 is a flow chart of an application in which the first N=3 spherical harmonics are generated in the target room by way of a MIMO system/method 300. For example, three fixed, adjustable or adaptive equalizing filter matrixes 301-303 provide the first three spherical harmonics (W, X and Y) of a virtual sound source for the approximate sound reproduction at the driver's position from input signal x(n). Equalizing filter matrixes 301-303 provide three sets of equalizing filter coefficients W_{cw}(z), W_{cx}(z), W_{cy}(z) in which each set includes Q equalizing filters and thus provides Q output signals. In the case of adaptive equalizing filters, the equalizing filter matrixes 301-303 may be constructed similar to those shown in FIGS. 1 and 2. Corresponding output signals of the filter matrixes are summed up by way of adders 304-309 and then supplied to three loudspeakers 310-312 arranged in a target room 313. For example, the output signals with q=1 are summed up and supplied to front right (Rf) loudspeaker 311, the output signals with q=2 are summed up and supplied to front left (Lf) loudspeaker 310 and the last output signals with q=Q are summed up and supplied to a rear right (Rs) 312. At a listening position (represented by a microphone array 314) then, the first three eigenmodes X, Y and Z are generated that together form the desired wave field of one virtual source.

In the target room 313, further loudspeakers, e.g., a rear left (Ls) loudspeaker 315, a sub-woofer (Sub) loudspeaker 316, and a center (C) loudspeaker 317 may be installed. The target room 313 is acoustically very unfavorable as it includes a window 318 and a French door 319 in a left wall and a door 320 in the right wall in an unbalanced configuration. Furthermore, a sofa 321 is disposed at the left wall and extends approximately to the center of the target room 313 and a table 322 is arranged in front of the sofa 321. A television set 323 is arranged at the front wall and in line of sight of the sofa 321. The front left (Lf) loudspeaker 310 and the front right (Rf) loudspeaker 311 are arranged on both sides of the television set 323 and the center (C) loudspeaker 317 is arranged below the television set 323. The sub-woofer (Sub) loudspeaker 316 is disposed in the corner between the front wall and the left wall. The loudspeaker arrangement on the rear wall including the rear left (Ls) loudspeaker 315 and the rear right (Ls) loudspeaker 312 do not share the same center line as the loudspeaker arrangement on the front wall including the front left (Lf) loudspeaker 310, the front right (Ls) loudspeaker 311, and center (C) loudspeaker 317. An exemplary sweet spot 324 is on the sofa 321 with the table 322 and the television set 323 in front. As can be seen, the loudspeaker setup shown in FIG. 3 is not based on a cylindrical or spherical base configuration and employs no regular distribution.

Modifications of the wave field can be made in a manner that can be seen from the following example in which a rotational element is introduced while decoding: P(r, ω)=S(jω)(Σₘ₌₀^{∞}j^{m}jₘ(kr)Σ_{0≤n≤n,σ=±1}B_{m,n}^{σ}Y_{m,n}^{σ}(θ, φ)Y_{m,n}^{σ}(θ_{Des}, φ_{Des})), wherein Y_{m,n}^{σ}(θ_{Des}, φ_{Des}) are modal weighting coefficients that turn the spherical harmonics in the desired direction (θ_{Des}, φ_{Des}), B_{m,n}^{σ} are the Ambisonic coefficients (weighting coefficients of the N^{th} spherical harmonic), Y_{m,n}^{σ}(θ, φ) is a complex spherical harmonic of m^{th} order, n^{th} grade (real part σ=1, imaginary part σ=−1), P(r, ω) is the spectrum of the sound pressure at a position r=(r, θ, φ), S(jω) is the input signal in the spectral domain, j is the imaginary unit of complex numbers and jₘ(kr) is the spherical Bessel function of first order and of n^{th} grade. The complex spherical harmonics Y_{m,n}^{σ}(θ, φ) may then be modeled by the MIMO system/method in the target room, i.e., by the corresponding equalizing filter coefficients. The Ambisonic coefficients B_{m,n}^{σ} are derived from an analysis of the wave field in the source room or a room simulation.

The exemplary MIMO system/method shown in FIG. 3 provides the basic functions (spherical harmonics) required by the HOA technique. In the example shown, the basic function is provided for a 1st-order 2D wave field that reproduces the center channel C of a multi-channel system such as surround sound system according ITU standard 5.1 with six input signals (e.g., C, FL, FR, SL, SR and Sub) for respective loudspeaker positions. However, in similar manner 3D wave fields, higher wave field orders and/or other channels may be implemented. The exemplary flexible system/method described above is integrated in an adaptive processing frame, which may operate in the wave field domain, so that a self-adjusting audio system may be established that can model an arbitrary wave field in the target room independent of where loudspeakers and/or microphones are positioned in the target room. For example, an Ambisonic decoder may be connected between microphone (array) 314 and the equalizing filter matrixes 301-303 that adaptively implement the secondary paths according to the target room. The MIMO system/method 300 allows for microphone and loudspeaker configurations that do not require specific basic configurations or regular distributions of the microphones and loudspeakers.

The MIMO system/method 300 may be integrated in an exemplary modal beamforming module 400 as depicted in FIG. 4. The beamforming module 400 controls a loudspeaker assembly with Q loudspeakers 401 (or Q groups of loudspeakers each with a multiplicity of loudspeakers such as tweeters, mid-frequency range loudspeakers and/or woofers) dependent on an (Ambisonics) input signal 402. The beamforming module 400 may include a modal weighting sub-module 403, a rotation sub-module 405 and a matrixing sub-module 407. The modal weighting sub-module 403 is supplied with the input signal 402 [ψ(Θ_{Des},φ_{Des})] which is weighted with modal weighting coefficients C₀(ω), C₁(ω) . . . C_{M}(ω) in the modal weighting sub-module 403 to provide N spherical harmonics (modes) 404 [Y₀(Θ_{Des},φ_{Des}) . . . Y_{N}(Θ_{Des},φ_{Des})]. The spherical harmonics 404 are transformed [Y^{σ}_{m,n}(Θ_{Des},φ_{Des})] by the rotation sub-module 405 using N×1 weighting coefficients to generate N rotated spherical harmonics 406 [Y⁺¹_{0,0}(Θ,φ), Y⁺¹_{0,1}(Θ,φ) . . . Y^{σ}_{m,n}(Θ,φ)]. The N rotated spherical harmonics 406 are transformed [Y⁺=(Y^{T}Y)⁻¹Y^{T}] into Q loudspeaker signals 408 [S₁(Θ₁,φ₁), S₂(Θ₂,φ_{Des}) . . . S_{Q}(Θ_{Q},φ_{Q})] by the matrixing sub-module 407 using a Q×N filter matrix which includes or is formed by the MIMO system/method 300.

It is noted that any software, firmware, algorithm and method used herein before for adaptation or in an adaptive process or procedure may be performed or applied in the time domain, frequency domain or wave domain as the case may be.

The description of embodiments has been presented for purposes of illustration and description. Suitable modifications and variations to the embodiments may be performed in light of the above description. The described systems and methods are exemplary in nature, and may include additional elements or steps and/or omit elements or steps. As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. A signal flow chart may describe a system, method or software executed by a processor for implementing the method dependent on the type of realization. e.g., as hardware, software or a combination thereof. A module may be implemented as hardware, software or a combination thereof.

1. An audio system configured to generate a sound wave field around a listening position in a target room, the audio system comprising:
a multiplicity of loudspeakers distributed in the target room; and
at least one modal beamformer module connected upstream of the multiplicity of loudspeakers and downstream of at least one input signal path that receives at least one Ambisonic input signal, the at least one modal beamformer module comprising a matrixing module that comprises a multiple-input multiple-output (MIMO) filter module.

2. The system of claim 1, wherein the modal beamformer module further comprises a modal weighting module and a modal rotation module.

3. The system of claim 1, wherein the (MIMO) filter module has fixed or adjustable transfer characteristics.

4. The system of claim 3, wherein the transfer characteristic is based on measurements in, or computed simulations of, the target room.

5. The system of claim 1, wherein the (MIMO) filter module has adaptive transfer characteristics.

6. The system of claim 5, wherein:
the (MIMO) filter module comprises a multiplicity of adaptive filters, each adaptive filter including a controllable filter and a filter controller;
the filter controller is configured to receive at least one error signal; and
the at least one error signal is provided by a microphone array with a multiplicity of microphones disposed in the target room.

7. The system of claim 6, wherein the microphone array is configured to provide an Ambisonics detection signal.

8. An audio reproduction method configured to generate a sound wave field around a listening position in a target room, the audio reproduction method comprising:
generating sound signals to be reproduced at a multiplicity of positions that are distributed in the target room;
executing a modal beamforming algorithm via a processor to provide the sound signals; and
processing an Ambisonic input signal according to the modal beamforming algorithm, the modal beamforming algorithm including matrixing according to a multiple-input multiple-output (MIMO) filtering algorithm.

9. The method of claim 8, wherein the modal beamformer algorithm further comprises a modal weighting algorithm and a rotation algorithm.

10. The method of claim 8, wherein the MIMO filtering algorithm has fixed or adjustable transfer characteristics.

11. The method of claim 10, wherein the transfer characteristic is based on measurements in, or computed simulations of, the target room.

12. The method of claim 8, wherein the MIMO filtering algorithm has adaptive transfer characteristics.

13. The method of claim 12, wherein:
the (MIMO) filtering algorithm comprises a multiplicity of adaptive filtering algorithms, each adaptive filtering algorithm including a controllable filtering algorithm and a filter control algorithm;
the filter control algorithm is configured to receive at least one error signal; and
the at least one error signal is provided by a microphone array with a multiplicity of microphones disposed in the target room.

14. The method of claim 13, wherein the microphone array is configured to provide an Ambisonics detection signal.

15. A computer program product configured to cause the processor to execute the method of claim 8.

16. An audio system configured to generate a sound wave field around a listening position, the audio system comprising:
a multiplicity of loudspeakers distributed in a target room;
a processor; and
at least one modal beamformer module connected to the multiplicity of loudspeakers and to at least one input signal path, the at least one modal beamformer being executed by the processor to receive at least one Ambisonic input signal, the at least one modal beamformer module including a matrixing module that comprises a multiple-input multiple-output (MIMO) filter module.

17. The system of claim 16, wherein the modal beamformer module further comprises a modal weighting module and a modal rotation module.

18. The system of claim 16, wherein the (MIMO) filter module has fixed or adjustable transfer characteristics.

19. The system of claim 18, wherein the transfer characteristic is based on measurements in, or computed simulations of, the target room.

20. The system of claim 16, wherein the (MIMO) filter module has adaptive transfer characteristics.
